(19) United States
(12) Patent Application Publication
(10) Pub. No.: US 2020/0208882 A1
(43) Pub. Date: Jul. 2, 2020

(54) REFRIGERATION CYCLE APPARATUS

(71) Applicant: HITACHI-JOHNSON CONTROLS AIR CONDITIONING, INC., Tokyo (JP)

(72) Inventors: Ryo OTA, Tokyo (JP); Koji NAITO, Tokyo (JP); Hideyuki UEDA, Tokyo (JP)

(21) Appl. No.: 16/818,058

(22) Filed: Mar. 13, 2020

Related U.S. Application Data
(63) Continuation of application No. PCT/JP2019/033340, filed on Aug. 26, 2019.

(30) Foreign Application Priority Data
Aug. 31, 2018 (JP) 2018-163602

(51) Int. Cl. F25B 1/00; F25B 31/00; F25B 9/00; C09K 5/04

(52) U.S. Cl. CPC F25B 1/00; F25B 31/002; C09K 2205/128; C09K 5/044; F25B 9/006

(57) ABSTRACT

A refrigeration cycle apparatus including, a compressor, a condenser, a pressure reducer, and an evaporator that evaporates the refrigerant. The refrigerant is a mixed refrigerant which contains refrigerant components of difluoromethane, pentafluoroethane and trifluoroiodomethane and which has a global warming potential and a specific vapor pressure. The compressor is a sealed electric compressor which includes a compression mechanism and a motor to drive this compression mechanism, and which is charged with a refrigerator oil to lubricate a sliding portion, and the refrigerator oil is polyvinyl ether oil, and contains 0.1% by mass to 2.0% by mass of a stabilizer constituted by at least one of an alicyclic epoxy compound and a monoterpene compound, 0.1% by mass to 2.0% by mass of an acid scavenger constituted by an aliphatic epoxy compound, and 0.1% by mass to 2.0% by mass of an extreme pressure agent constituted by tertiary phosphate.

### CROSS-REFERENCE TO RELATED APPLICATION

The present application is a continuation application of PCT/JP2019/033340, filed on Aug. 26, 2019, which claims the benefit of priority of Japanese Patent Application No. 2018-163602, filed on Aug. 31, 2018, the entire contents of which are incorporated herein by reference.

### BACKGROUND

### 1. Technical Field

The present disclosure relates to a refrigeration cycle apparatus.

### 2. Related Art

Various policies to prevent global warming are internationally being implemented. The twenty-first session of the Conference of the Parties (COP21) to the United Nations Framework Convention on Climate Change held in 2015 adopted the Paris Agreement that requires nations to keep the international average temperature rise well below 2° C. compared with the pre-industrial level and to try to suppress the temperature rise to 1.5° C.

Presently, the average temperature rise is about 1° C. after the industrial revolution. In order to keep the average temperature rise within 2° C., the average CO₂ concentration needs to be suppressed to 450 ppm. However, it is estimated, from the current CO₂ emission increase, that this level will be exceeded in 30 years from now. Japan has declared its intention to proceed with the policy setting a target of 1.5° C., and is predicted to have a tough time to handle the target.

A refrigerant used in refrigeration air-conditioning apparatuses is often a fluorine compound (fluorine-based refrigerant), excluding when used in small-sized apparatuses from the viewpoint of safety. A bond of carbon C and fluorine F of a fluorine-based refrigerant, that is, the presence of a C—F bond, reduces flammability. Meanwhile, the presence of a C—F bond is likely to cause an infrared absorption region to exist in a window region (a wavelength region other than an atmospheric absorption wavelength) of earth radiation (black body radiation at 288 K in average: mainly, infrared light). Also, the presence of a C-F bond, which has a large bond energy, has an extended life in the atmosphere, with the result that a global warming potential (GWP) is likely to increase.

Therefore, Japan has proceeded with legislation for preventing global warming related to a fluorine-based refrigerant. Regarding the use and management of a fluorine-based refrigerant used in refrigeration air-conditioning apparatuses, apparatuses and substances to be controlled are stipulated in the “Act on Rational Use and Proper Management of Fluorocarbons (Fluorocarbons Emission Control Law)”.

Specific substances to be controlled are ozone-depleting substances (mainly, a fluorine compound containing chlorine or bromine) controlled by the “Act on the Protection of the Ozone Layer Through the Control of Specified Substances and Other Measures” and substances (mainly, high-GWP substances containing hydrogen, fluorine and carbon) stipulated in the “Act on Promotion of Global Warming Countermeasures”. Although there is an international trend toward controlling a refrigerant in this manner, lowering the GWP of a refrigerant tends to increase flammability.

The GWPs of R410A [HFC (hydrofluorocarbon) 32/HFC125 (50% by mass/50% by mass)] and R404A [HFC125/HFC143a/HFC134a (44% by mass/52% by mass/4% by mass)], which are a refrigerant used in a refrigeration cycle apparatus (sometimes called a refrigeration air-conditioning apparatus, an air-conditioner, an air-conditioning apparatus, or the like), are as high as R410A =1924 and R404A =3943. Therefore, it is necessary to develop a refrigeration cycle apparatus using an alternative low-GWP refrigerant.

Examples of this alternative refrigerant may include, for the reasons of thermophysical properties, low GWPs, low toxicity, low flammability, and the like, difluoromethane (HFC32) (GWP=677), 2,3,3,3-tetrafluoropropene (HFO (hydrofluoroolefin) 1234yf) (GWP=0), 1,3,3,3-tetrafluoropropene (HFO1234ze) (GWP=1), trifluoroethene (HFO1123) (GWP<1), 3,3,3-trifluoropropene (HFO1243zf) (GWP=0), a mixed refrigerant of HFO, HFC32, HFC125, HFC134a, and the like, hydrocarbon such as propane and propylene, a low-GWP hydrofluorocarbon such as monofluoroethane (HFC161) and difluoroethane (HFC152a), and a low-boiling compound containing an element such as iodine, bromine, and chlorine for achieving non-flammability.

Among these refrigerant candidates, HFC32, HFO1234yf, and HFO1234ze are defined as an inert gas by the Revised Regulation (November, 2016) on Safety of Refrigeration of the High Pressure Gas Safety Act, for a multi air conditioner for buildings which is high in capacity and large in refrigerant charge amount as an air conditioner. However, since these refrigerants are slightly flammable, it is necessary, for an air conditioner having a capacity of 5 refrigeration tons or more, to post the names to specific inactive gases and to dispose a structure for preventing the refrigerants from remaining after they have leaked and a detection alarm at a location where the refrigerants may remain. From such a background, Honeywell Inc. has proposed R466A (a three-component mixed refrigerant of R32/R125/trifluoroiodomethane (CF3I)) which is non-flammable and has a GWP of 750 or less.

On the other hand, for a refrigerator, a non-flammable mixed refrigerant containing HFO1234yf and HFO01234ze both having a GWP of 1500 or less attracts attention from the viewpoint of the above-described Fluorocarbons Emission Control Law, and a product using R448A and R449A is under development. However, unless the mixed refrigerant has a GWP of about 1100 to 1400, it is unlikely to become non-flammable. Thus, in order to further lower the GWP of a refrigerant used in refrigerators, a low-flammable refrigerant or a non-flammable refrigerant is necessary. Under such circumstances, for example, JP-A-2018-44169 discloses a method for mixing 5% by mass to 18% by mass of trifluoroiodomethane.

### SUMMARY

A refrigeration cycle apparatus according to an embodiment of the present disclosure includes: a compressor that compresses a refrigerant; a condenser that condenses the refrigerant compressed by the compressor; a pressure reducer that reduces in pressure the refrigerant condensed by the condenser; and an evaporator that evaporates the refrigerant reduced in pressure by the pressure reducer. The refrigerant is a mixed refrigerant which contains refrigerant components of difluoromethane, pentafluoroethane and trifluoroiodomethane and which has a global warming potential of 750 or less and a vapor pressure at 25° C. of 1.1 MPa to 1.8 MPa, the compressor is a sealed electric compressor which includes, in a sealed container, a compression mechanism and a motor to drive this compression mechanism, and which is charged with a refrigerator oil to lubricate a sliding portion, and the refrigerator oil is polyvinyl ether oil, and contains 0.1% by mass to 2.0% by mass of a stabilizer constituted by at least one of an alicyclic epoxy compound and a monoterpene compound, 0.1% by mass to 2.0% by mass of an acid scavenger constituted by an aliphatic epoxy compound, and 0.1% by mass to 2.0% by mass of an extreme pressure agent constituted by tertiary phosphate.

### BRIEF DESCRIPTION OF THE DRAWINGS

FIG. 1 is a schematic configuration diagram indicating an example in which a refrigeration cycle apparatus according to an embodiment is applied to a multi air conditioner for buildings;

FIG. 2 is a schematic configuration diagram indicating an example in which a refrigeration cycle apparatus according to the embodiment is applied to a refrigerator; and

FIG. 3 is a vertical cross-sectional diagram indicating an example of a scroll compressor as a sealed electric compressor.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Large-sized air-conditioners like a multi air conditioner for buildings are high in refrigerating capacity and large in refrigerant charge amount, as described above. Therefore, for such large-sized air-conditioners, it is necessary to use a mixed refrigerant that is considerably lower in flammability than HFC32 and has a GWP of 750 or less. Also, for refrigerators, it is necessary to use a non-flammable mixed refrigerant that has a GWP of 1000 or less. In addition, since there is further increasing demand for the protection of global environment in recent years, a typical refrigeration air-conditioning technology, for example, even the method disclosed in JP-A-2018-44169, hardly satisfies necessary aspects in a thorough manner. That is, a trifluoroiodomethane-containing mixed refrigerant, which is poor in thermochemical stability, decomposes in the coexistence with hydrogen or water into hydrogen iodide, hydrofluoric acid, and carbonyl fluoride. These decomposition products, particularly hydrogen iodide and hydrofluoric acid, cause polyvinyl ether oil or organic materials used as a refrigerator oil to be abnormally degraded or corroded.

Also, since the lubricity of polyvinyl ether oil is lower than that of polyol ester oil or the like, an extreme pressure agent such as tricresyl phosphate as tertiary phosphate is often added. However, the above-described decomposition products seriously deteriorate and deplete tricresyl phosphate. Accordingly, the total acid number of a refrigerator oil considerably increases, and the friction and wear of a compressor (for example, a sealed electric compressor) for compressing a refrigerant is hardly suppressed. Thus, reliability is considerably reduced. Therefore, a trifluoroiodomethane-containing mixed refrigerant has the problem of being difficult to ensure the long-term reliability of an air-conditioner (refrigeration cycle apparatus).

In this manner, a currently used refrigeration cycle apparatus including a compressor that uses a trifluoroiodomethane-containing mixed refrigerant does not have technologies sufficient for ensuring product reliability. That is, although the GWP itself of a trifluoroiodomethane-containing mixed refrigerant is low, the thermochemical stability of the refrigerant is not maintained depending on the water content introduced into a refrigeration cycle apparatus, thereby failing to ensure the long-term reliability of a refrigerator cycle apparatus.

The present disclosure has been made in view of the above-described circumstances, and has as its subject matter to provide a refrigeration cycle apparatus that is low in flammability, has a GWP of 750 or less, and can use, as a refrigerator oil, polyvinyl ether oil which has poor thermochemical stability with a trifluoroiodomethane-containing mixed refrigerant, even when the mixed refrigerant is used.

A refrigeration cycle apparatus according to the present disclosure which has solved the above-described problems includes: a compressor that compresses a refrigerant; a condenser that condenses the refrigerant compressed by the compressor; a pressure reducer that reduces in pressure the refrigerant condensed by the condenser; and an evaporator that evaporates the refrigerant reduced in pressure by the pressure reducer. The refrigerant is a mixed refrigerant which contains refrigerant components of difluoromethane, pentafluoroethane and trifluoroiodomethane and which has a global warming potential of 750 or less and a vapor pressure at 25° C. of 1.1 MPa to 1.8 MPa, the compressor is a sealed electric compressor which includes, in a sealed container, a compression mechanism and a motor to drive this compression mechanism, and which is charged with a refrigerator oil to lubricate a sliding portion, and the refrigerator oil is polyvinyl ether oil, and contains 0.1% by mass to 2.0% by mass of a stabilizer constituted by at least one of an alicyclic epoxy compound and a monoterpene compound, 0.1% by mass to 2.0% by mass of an acid scavenger constituted by an aliphatic epoxy compound, and 0.1% by mass to 2.0% by mass of an extreme pressure agent constituted by tertiary phosphate.

According to the present disclosure, there can be provided a refrigeration cycle apparatus that is low in flammability, has a GWP of 750 or less, and can use, as a refrigerator oil, polyvinyl ether oil which has poor thermochemical stability with a trifluoroiodomethane-containing mixed refrigerant, even when the mixed refrigerant is used. The subject matter, configuration, and effect other than those described above will be clarified by the following description of embodiments.

Hereinafter, embodiments of the present disclosure will be described in detail with reference to the drawings. It is noted that in the drawings, sizes and shapes of members are sometimes schematically indicated by deformation or exaggeration for the convenience of explanation. As described herein, the term “to” between numerical values indicates that the values before and after the term express the lower limit and the upper limit respectively. For value ranges described in a stepwise manner herein, the upper limit or the lower limit described in one value range may be replaced with the upper limit or the lower limit described in another value range described in a stepwise manner.

The refrigeration cycle apparatus according to the present embodiment is an apparatus that has the capability to cool an object to be cooled taking advantage of a thermodynamic refrigeration cycle formed by a refrigerant. The refrigeration cycle apparatus may have the capability to perform a thermal cycle opposite a refrigeration cycle, as long as it has the capability to perform cooling. The refrigeration cycle apparatus can be applied to, for example, various refrigeration air-conditioning apparatuses such as an air-conditioner and a refrigerator.

The refrigeration cycle apparatus includes a condenser (outdoor heat exchanger) that condenses the refrigerant compressed by the compressor, a pressure reducer that reduces in pressure the refrigerant condensed by the condenser, and an evaporator (indoor heat exchanger) that evaporates the refrigerant reduced in pressure by the pressure reducer. That is, the refrigerant circulates and flows through the compressor, condenser, pressure reducer, and evaporator included in the refrigeration cycle apparatus, via a pipe, switching valve, and the like. A specific example (application example) of the above-described configuration and operation in the refrigeration cycle apparatus will be described later.

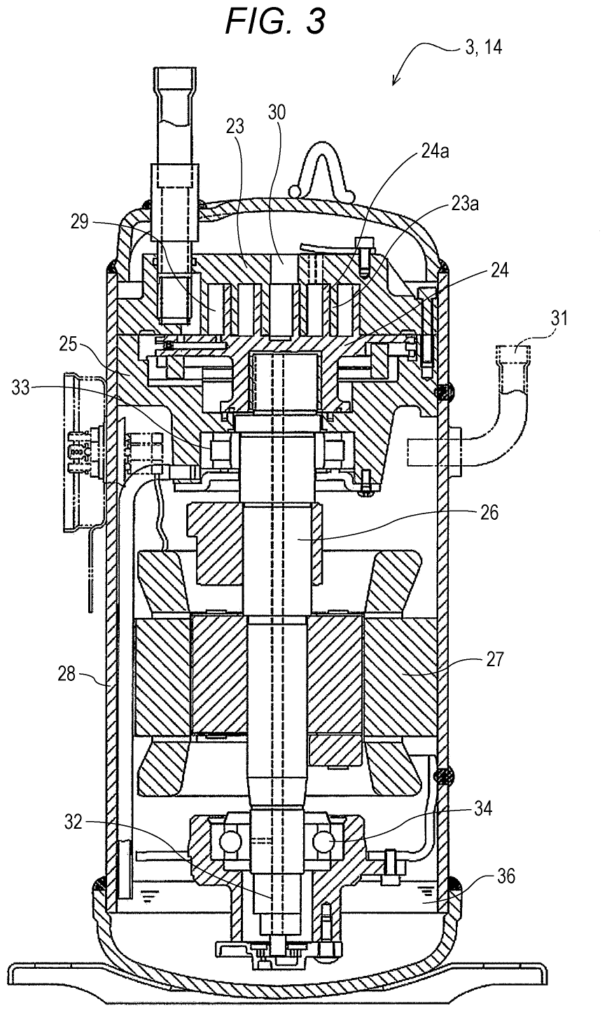

Also, the refrigeration cycle apparatus includes a sealed electric compressor (compressor). The sealed electric compressor has, in a sealed container (pressure container), a sliding portion where members slide on each other. Also, the sealed electric compressor houses a compression mechanism (refrigerant compression unit) for compressing a refrigerant and a motor for driving this compression mechanism. Into the sealed electric compressor, a low-flammable mixed refrigerant or a non-flammable mixed refrigerant and a refrigerator oil are charged. It is noted that specific examples of the sealed electric compressor include a scroll compressor, screw compressor, rotary compressor, twin rotary compressor, two-stage compression rotary compressor, and swing-type compressor with a roller and a vane integrated. The compression mechanism will be described later with reference to FIG. 3.

### <Refrigerant>

A refrigerant used in the present embodiment is a mixed refrigerant that contains, as a refrigerant component, three refrigerants: difluoromethane (HFC32), pentafluoroethane (HFC125), and trifluoroiodomethane (R13I1). It is noted that for obtaining vapor pressure corresponding to the capacity of a refrigeration cycle apparatus, the refrigerant in the present embodiment may further contain, other than the three refrigerants, at least one refrigerant of HFO1234yf, HFO1234ze, HFC134a, HFO01123, and the like to adjust vapor pressure in relation to the refrigerating capacity.

Also, the refrigerant has a global warming potential (GWP) of 750 or less and a vapor pressure at 25° C. of 1.1 MPa to 1.8 MPa. The refrigerant satisfies these conditions by adjusting the types of refrigerants to be mixed and the component make-up thereof.

When the refrigerant has a GWP of 750 or less, environmental performance is excellent, and conformity with laws and regulations such as the Fluorocarbons Emission Control Law can be improved. The GWP of the refrigerant is preferably 500 or less, more preferably 150 or less, further preferably 100 or less, particularly preferably 75 or less. As a GWP, a value (value for 100 years) in the Fifth Assessment Report (AR5) of the Intergovernmental Panel on Climate Change (IPCC) is used. Also, as a GWP of a refrigerant not described in AR5, a value described in another known literature may be used, or a value calculated or measured using a known method may be used.

Also, when the vapor pressure at 25° C. is in the range of 1.1 MPa to 1.8 MPa, few changes in system design are necessary to a currently used common refrigeration cycle apparatus, and refrigerating capacity such as air conditioning capacity can be equivalent. The vapor pressure at 25° C. can be estimated by using, for example, PERPROP Version 9.1 (database software for refrigerant thermophysical properties by the National Institute of Standards and Technology (NIST)). The estimation condition is, for example, an evaporation temperature of 0° C., a condensation temperature of 40° C., a superheating degree for an evaporator of 5° C., a supercooling degree for a condenser of 5° C., and no loss.

The present embodiment has a make-up in which the above-described three refrigerants HFC32, HFC125 and R13I1 are combined as a main component, thereby achieving a mixed refrigerant (refrigerant composition) having the above-described characteristics. Specifically, HFC32 improves refrigerating capacity and efficiency, HFC125 decreases a temperature gradient, and R13I1 decreases a GWP and drastically decreases flammability.

It is difficult to replace the above-described three refrigerants (HFC32, HFC125 and R13I1) with other refrigerants. However, as described above, it is possible to improve performance depending on its intended use or as necessary, by adding and mixing other refrigerants to these three refrigerants. For example, when the vapor pressure is desired to be higher, it can be achieved by formulating an appropriate amount of HFO1123. Also, when the refrigerant is used as an alternative refrigerant to R404A, a HFC1234-based refrigerant can be formulated to reduce the pressure such that characteristics similar to an R404A refrigerant is obtained.

The mixed refrigerant (refrigerant composition) used in the present embodiment preferably has a formulating ratio that is 30% by mass to 60% by mass of difluoromethane (HFC32), 5% by mass to 25% by mass of pentafluoroethane (HFC125), and 30% by mass to 60% by mass of trifluoroiodomethane (R13I1) with respect to a total mass (100% by mass) of the mixed refrigerant. When the content of difluoromethane (HFC32) is 30% by mass to 60% by mass, refrigerating capacity and efficiency further improve. Also, when the content of pentafluoroethane (HFC125) is 5% by mass to 25% by mass, a temperature gradient can be further suppressed. Furthermore, when the content of trifluoroiodomethane (R13I1) is 30% by mass to 60% by mass, a GWP can be further lowered while flammability can be further suppressed.

In the present embodiment, a refrigerant composition that has a suppressed GWP of 750 or less, is flame retardant (low-flammable), and obtains sufficient performance in terms of refrigerating capacity and efficiency is achieved by adjusting the three refrigerants and the formulating ratio thereof as described above.

It is noted that as long as the three refrigerants (HFC32, HFC125 and R13I1) maintain the above-described formulating ratio of the three refrigerants, a refrigerant other than the above-described HFO1123- and HFC1234-based refrigerants can be mixed, and an additive can be added, within the range that does not impair the effects of the present disclosure. This enables the properties of the mixed refrigerant and additive to be added while maintaining the same performance as the above-described refrigerant. For example, when the vapor pressure of the refrigerant is desired to be higher, a refrigerant to increase vapor pressure may be mixed in a necessary amount.

### <Refrigerator Oil>

In the present embodiment, polyvinyl ether oil is used as the refrigerator oil to be included (charged) into the above-described sealed electric compressor. It is noted that a refrigerator oil preferably has a kinematic viscosity at 40° C. of 22 to 84 mm²/s. When the kinematic viscosity at 40° C. of a refrigerator oil is within this range, the refrigerator oil can be applied to sealed electric compressors having various forms. Also, when the kinematic viscosity at 40° C. of a refrigerator oil is within this range, the lubricity inside a compressor and the sealed property of a compression unit when a refrigerant has dissolved in oil can be ensured. The kinematic viscosity at 40° C. of a refrigerator oil can be measured based on standards such as ISO (International Organization for Standardization) 3104 and ASTM (American Society for Testing and Materials) D445 and D7042.

In the present embodiment, the low-temperature-side critical solution temperature between a mixed refrigerant and a refrigerator oil is preferably +10° C. or lower. Therefore, a compound represented by formula 1 is preferably used as the polyvinyl ether oil. Accordingly, low-temperature two layer separation is achieved. That is, a temperature at which a mixed refrigerant and a refrigerator oil are separated into two layers can be lowered. It is noted that R1 in the following formula is a methyl group, ethyl group, propyl group, butyl group or isobutyl group, and n is 5 to 15.

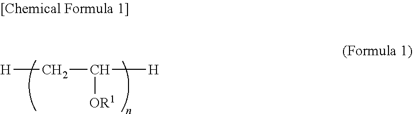

A refrigerator oil can contain water. The water content in a refrigerator oil (water content in oil) can be measured in accordance with, for example, JIS K2275-3:2015 “Crude Petroleum and Petroleum Products—Determination of Water—Part 3: Coulometric Karl Fischer titration method”. When the water content in oil of a refrigerator oil measured in this manner is, for example, 600 ppm or less, the refrigerator oil can be used without problems. It is noted that in view of decomposition products (particularly, hydrogen iodide and hydrofluoric acid) generated through the decomposition of a mixed refrigerant (particularly, trifluoroiodomethane), and the deterioration and depletion of an extreme pressure agent (particularly, tricresyl phosphate) due to the decomposition products, the water content in oil is preferably as low as possible. In the present embodiment, from the viewpoint of inhibiting the deterioration and depletion of an extreme pressure agent, the water content in oil is, for example, preferably 500 ppm or less, more preferably 300 ppm or less, further preferably 200 ppm or less, further more preferably 100 ppm or less. In the present embodiment, in order to concretely realize such a water content in oil, the refrigeration cycle apparatus may include a dryer to trap water contained in a refrigerator oil. An example of such a dryer includes, but not limited to, synthetic zeolite.

A refrigerator oil used in the present embodiment, that is, polyvinyl ether oil, contains a stabilizer, an acid scavenger, and an extreme pressure agent as additives. It is noted that the polyvinyl ether oil may be freely added with, as an additive other than these additives, a lubricity improver, antioxidant, defoamer, metal deactivator, and the like, within the range that exerts the effect of the present disclosure. In particular, in order to inhibit the corrosion of the inner surface of a copper pipe, a metal deactivator represented by benzotriazole or the like is desirably formulated.

A stabilizer plays a role in detoxifying decomposition products of a mixed refrigerant in an early stage. Examples of a stabilizer include an alicyclic epoxy compound and a monoterpene compound. As a stabilizer, one of these compounds can be used, or both can be simultaneously used.

As an alicyclic epoxy compound, a difunctional epoxy compound having a molecular weight of 200 to 400, for example, can be suitably used. An example of such a difunctional epoxy compound includes, but not limited to, 3,4-epoxycyclohexylmethyl-3,4-epoxycyclohexane carboxylate. A suitable example of a monoterpene compound to be used includes monocyclic monoterpene. Examples of monocyclic monoterpene include limonene oxide, d-limonene, l-limonene, a-pinene, β-pinene, a-terpinene, and γ-terpinene each having a cyclohexane ring.

An acid scavenger plays a role in reacting with an acid compound (for example, fatty acid) and water present in oil to trap the acid compound and water, so that influences by the acid compound and water are reduced. A suitable example of an acid scavenger to be used includes an aliphatic monofunctional epoxy compound as a compound having an epoxy ring. Particularly suitable examples of an acid scavenger to be used include alkyl glycidyl ester and alkyl glycidyl ether each having a molecular weight of 150 to 250.

An extreme pressure agent plays a role in improving lubricity. A suitable example of an extreme pressure agent to be used includes tertiary phosphate. Specific suitable examples of an extreme pressure agent include tricresyl phosphate, triphenyl phosphate and a derivative thereof, trixylenyl phosphate, cresyl diphenyl phosphate, 2-ethylhexyl diphenyl phosphate, and tris(2-ethylhexyl) phosphate.

Also, the refrigerator oil used in the present embodiment preferably further includes, in addition to these additives, the above-described antioxidant. An example of an antioxidant includes, but not limited to, phenol-based DBPC (2,6-di-t-butyl-p-cresol).

In the present embodiment, the contents of the above-described stabilizer, acid scavenger and extreme pressure agent are all in the range of 0.1% by mass to 2.0% by mass relative to the refrigerator oil. It is noted that the contents of the above-described specific examples of a stabilizer, acid scavenger and extreme pressure agent are such that, for example, when two or more of the above-described compounds are used as a stabilizer, a sum of the contents of the two or more compounds used as a stabilizer is in the range of 0.1% by mass to 2.0% by mass relative to the refrigerator oil. The same applies to an acid scavenger and an extreme pressure agent. This allows the refrigerator oil to include a predefined amount of an extreme pressure agent, so that the refrigerator oil has excellent lubricity. Also, since the refrigerator oil includes predefined amounts of an acid scavenger and stabilizer, hydrogen iodide and hydrofluoric acid generated through the decomposition of trifluoroiodomethane due to oxygen and water contained in the mixed refrigerant can be trapped or the like for detoxification. Therefore, the total acid number of a refrigerator oil and the fluorine content in oil are unlikely to increase.

Also, when an antioxidant is included, the antioxidant is preferably added in an amount of 0.1% by mass to 2.0% by mass relative to the refrigerator oil. Accordingly, the total acid number of the refrigerator oil is further unlikely to increase.

### <Application Example to Air-Conditioner>

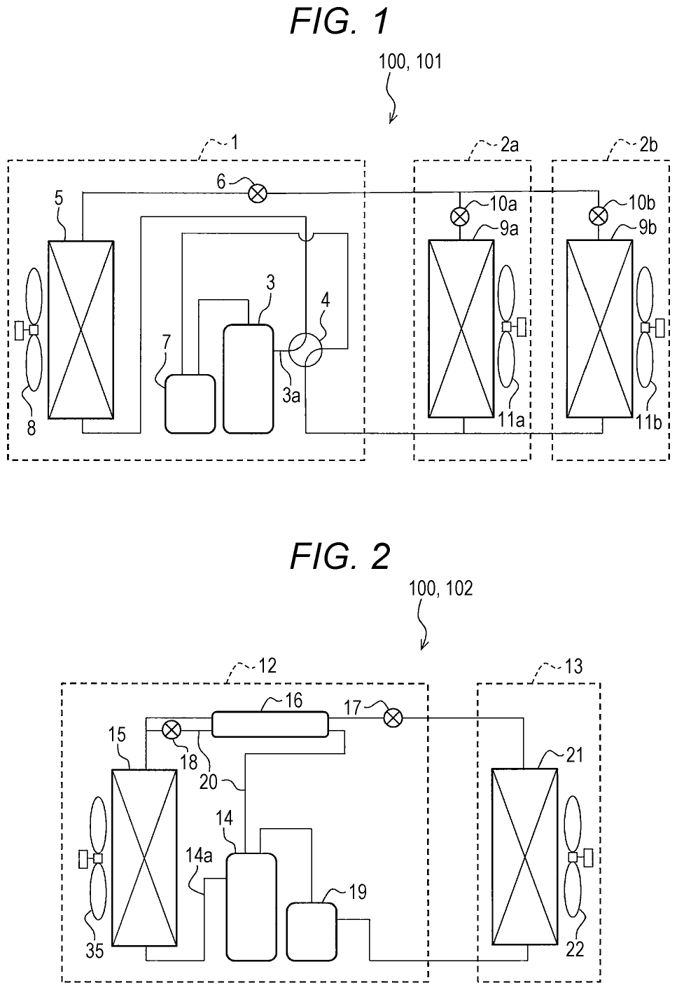

FIG. 1 is a schematic configuration diagram indicating an example in which a refrigeration cycle apparatus 100 according to the present embodiment is applied to a multi air conditioner for buildings (multi-chamber-type air-conditioner) 101. That is, FIG. 1 indicates an example of the refrigeration cycle apparatus 100 using the above-described mixed refrigerant and refrigerator oil. As indicated in FIG. 1, the multi air conditioner for buildings 101 includes an outdoor unit 1 and a plurality of indoor units 2a and 2b. It is noted that although FIG. 1 indicates, due to limitations of space and illustration, an example in which the multi air conditioner for buildings 101 includes two indoor units 2a and 2b, the number of indoor units is not limited to two, and can be three or more.

As indicated in FIG. 1, the outdoor unit 1 houses a compressor 3, a four-way valve 4 that functions as a switching valve, an outdoor heat exchanger 5 which is a condenser, a pressure reducer (outdoor expansion valve) 6 constituted by an electronic expansion valve, a thermal expansion valve, or the like, an accumulator 7 for storing a mixed refrigerant, and an air blower 8 for ventilating the outdoor heat exchanger 5.

The compressor 3 is constituted by a sealed electric compressor that includes, in a sealed container, a compression mechanism having a sliding portion, and a motor 27 (see FIG. 3) for driving this compression mechanism. It is noted that as described above, the compression mechanism will be described later with reference to FIG. 3.

As indicated in FIG. 1, the indoor units 2a and 2b respectively include indoor heat exchangers 9a and 9b each being an evaporator. Also, the indoor units 2a and 2b respectively house: pressure reducers (indoor expansion valves) 10a and 10b each constituted by an electronic expansion valve, a thermal expansion valve, or the like; air blowers 11a and 11b for ventilating the indoor heat exchangers 9a and 9b; and the like. Also, the outdoor unit 1 and the indoor units 2a and 2b, which constitutes the multi air conditioner for buildings 101, are charged with the above-described mixed refrigerant and refrigerator oil.

The multi air conditioner for buildings 101 having the above-described configuration acts in the following manner to perform a cooler operation and a heater operation. It is noted that the below-described refrigerant gas, liquid refrigerant, gas-liquid two-phase refrigerant, and gas refrigerant are the above-described refrigerant (mixed refrigerant) whose conditions have been changed.

First, when a cooler operation is performed, a high-temperature, high-pressure refrigerant gas adiabatically compressed in the compressor 3 passes through a pipe 3a and the four-way valve 4 into the outdoor heat exchanger 5 which is a condenser. The refrigerant gas having flown into the outdoor heat exchanger 5 is cooled by the outdoor heat exchanger 5 and ventilation air of the air blower 8 to become a high-pressure liquid refrigerant. This liquid refrigerant is decompressed in the pressure reducer 6, and expanded to become a gas-liquid two-phase refrigerant (a low-temperature, low-pressure liquid which slightly contains gas). The gas-liquid two-phase refrigerant flows into the indoor heat exchangers 9a and 9b each being an evaporator. The gas-liquid two-phase refrigerant having flown into the indoor heat exchangers 9a and 9b draws heat away from indoor air to evaporate, and becomes a low-temperature, low-pressure gas refrigerant. This gas refrigerant passes through the four-way valve 4 again, and flows into the accumulator 7. A low-temperature, low-pressure liquid refrigerant that has not evaporated in the indoor heat exchangers 9a and 9b is separated in the accumulator 7, and the low-temperature, low-pressure gas refrigerant flows into the compressor 3. Thereafter, this refrigeration cycle is repeated.

On the other hand, when a heater operation is performed, the four-way valve 4 is switched such that a high-temperature, high-pressure gas refrigerant flows into the indoor heat exchangers 9a and 9b. That is, the flowing direction of a refrigerant is opposite that of a cooler operation. Thus, in this case, the indoor heat exchangers 9a and 9b serve as a condenser, and the outdoor heat exchanger 5 serves as an evaporator.

### <Application Example to Refrigerator>

FIG. 2 is a schematic configuration diagram indicating an example in which the refrigeration cycle apparatus 100 according to the present embodiment is applied to a refrigerator 102. That is, FIG. 2 indicates an example of the refrigeration cycle apparatus 100 using the above-described mixed refrigerant and refrigerator oil. As indicated in FIG. 2, the refrigerator 102 includes a heat source device 12 and a cooler unit 13. The cooler unit 13 is a device that cools an object to be cooled, and is, for example, a showcase or a refrigeration room. The cooler unit 13 is constituted by an evaporator (use-side heat exchanger) 21, an air blower 22 that ventilates the use-side heat exchanger 21, and the like. The evaporator 21 exchanges heat between a refrigerant and air inside the unit so that the refrigerant evaporates.

The heat source device 12 includes a compressor 14, a condenser (heat source-side heat exchanger) 15, a supercooler 16, pressure reducers 17 and 18 constituted by an electronic expansion valve or the like, an accumulator 19, and an air blower 35 that ventilates the condenser 15.

The accumulator 19, the compressor 14, the condenser 15, the supercooler 16, the pressure reducer 17, and the use-side heat exchanger 21 are connected in this order in a closed ring shape via pipes through which a refrigerant flows. Also, a supercooling refrigerant circuit 20 is disposed in which a part of a liquid refrigerant exiting the condenser 15 branches off to be decompressed in the pressure reducer 18, and flows into the supercooler 16 to further cool the mainstream of a refrigerant flowing through the supercooler 16. The supercooling refrigerant circuit 20 extends from a pipe, through which the mainstream of a refrigerant flows, to the supercooler 16, and from the other end of the supercooler 16 to the compressor 14.

These devices and pipes connecting the devices form a refrigeration cycle as a circulating path of a refrigerant between the heat source device 12 and the cooler unit 13. In the same manner as the above-described multi air conditioner for buildings 101, the above-described refrigerant is charged in the refrigeration cycle. Also, the above-described refrigerator oil is charged in the compressor 14.

The compressor 14 is constituted by a sealed electric compressor that includes, in a sealed container, a compression mechanism having a sliding portion, and a motor 27 (see FIG. 3) to drive this compression mechanism. It is noted that as described above, the compression mechanism will be described later with reference to FIG. 3. The condenser 15 exchanges heat between a refrigerant and outside air so that the refrigerant is condensed.

A high-temperature, high-pressure refrigerant gas adiabatically compressed in the compressor 14 is discharged from a pipe 14a, and flows into the condenser 15. The refrigerant gas having flown into the condenser 15 is cooled to be condensed by the condenser 15 and ventilation air of the air blower 35 to become a high-pressure liquid refrigerant. A portion of the high-pressure liquid refrigerant having exited the condenser 15 branches off into the supercooling refrigerant circuit 20, while the remaining mainstream of a liquid refrigerant passes through the supercooler 16 to be further supercooled, thereafter expands in the pressure reducer 17 to become a low-temperature, low-pressure gas-liquid two-phase refrigerant which slightly contains gas, and is delivered into the cooler unit 13. The refrigerant delivered to the cooler unit 13 draws heat away from air to evaporate in the evaporator 21, and becomes a low-temperature, low-pressure gas refrigerant. This gas refrigerant passes through the accumulator 19, and then returns to the compressor 14. Thereafter, this refrigeration cycle is repeated.

Here, in the compressor 14 for the refrigerator 102, the compression ratio of a refrigerant is as high as about 10 to 20, and the temperature of a refrigerant gas is likely to become high. Therefore, as described above, a portion of the liquid refrigerant having exited the condenser 15 branches off into the supercooling refrigerant circuit 20, and becomes a gas-containing, low-temperature, low-pressure liquid refrigerant by the pressure reducer 18 such as a capillary tube to further supercool the high-pressure liquid refrigerant as a mainstream in the supercooler 16. The refrigerant having branched off into the supercooling refrigerant circuit 20 passes through the supercooler 16, and returns to an intermediate pressure part of the compressor 14 to lower the temperature of a sucked refrigerant so as to lower a discharge temperature. It is noted that although the refrigerant in the supercooling refrigerant circuit 20 returns to an intermediate pressure part of the compressor 14 in this example indicated in FIG. 2, the refrigerant may enter a suction side of the compressor 14.

<Configuration of compressor>

As the compressor 3 used in the air-conditioner 101 and the compressor 14 used in the refrigerator 102, a sealed electric compressor is used. An example of this sealed electric compressor will be described with reference to FIG. 3. FIG. 3 is a vertical cross-sectional diagram indicating an example of a scroll compressor as a sealed electric compressor.

The compressor 3 and the compressor 14 have the same configuration as indicated in FIG. 3. The compressors 3 and 14 include: a fixed scroll member 23 having a spiral fixed wrap 23a vertically disposed to an end plate; a revolving scroll member 24 having a spiral revolving wrap 24a, which has the substantially same shape as the fixed scroll member 23; a frame 25 that supports the revolving scroll member 24; a crankshaft 26 that revolves the revolving scroll member 24; a motor 27 that drives the crankshaft 26; and a sealed container 28 that houses these components.

The fixed wrap 23a and the revolving wrap 24a mesh with each other in a facing manner to form a compression mechanism. The revolving scroll member 24 is revolved by the crankshaft 26. Accordingly, compression chambers 29 are formed between the fixed scroll member 23 and the revolving scroll member 24, and a compression chamber 29 located outermost moves toward the center of the fixed scroll member 23 and the revolving scroll member 24 while gradually shrinking in volume in association with the revolving motion.

When the compression chamber 29 reaches the vicinity of the center of the fixed scroll member 23 and the revolving scroll member 24, the compression chamber 29 is connected to a discharge port 30, and a compressed refrigerant gas is discharged into the sealed container 28. The compressed gas discharged into the sealed container 28 is discharged from a pipe 31 disposed to the sealed container 28 to a refrigeration cycle outside the compressors 3 and 14.

The compressors 3 and 14 perform a compression action by the rotation of the crankshaft 26 at a constant speed or at a rotation speed corresponding to the voltage controlled by an inverter (not indicated). Also, an oil reservoir 36 is disposed below the motor 27. A refrigerator oil in this oil reservoir 36 passes through an oil hole 32 disposed to the crankshaft 26 by a pressure difference, and is supplied for the lubrication of a sliding portion between the revolving scroll member 24 and the crankshaft 26, and for the lubrication of a rolling bearing which constitutes a main bearing 33 to support a main shaft of the crankshaft 26 and a sub-bearing 34 to support a sub-shaft portion of the crankshaft 26.

### EXAMPLES

Next, the present disclosure will be more specifically described by indicating examples which satisfy aspects necessary for the present disclosure, and comparative examples which do not. However, the present disclosure is not limited to the following description.

As the above-described refrigerant composition of the present embodiment, a mixed refrigerant based on three components of HFC32/HFC125/R13I1 (trifluoroiodomethane) was used. The formulation ratio of the three components of the mixed refrigerant is 50% by mass/10% by mass/40% by mass when a multi air conditioner for buildings is assumed, and 28% by mass/17% by mass/55% by mass when a refrigerator is assumed. These mixed refrigerants all have a GWP of around 730. Also, the vapor pressures at 25° C. of these mixed refrigerants were estimated using PERPROP Version 9.1 (database software for refrigerant thermophysical properties by the National Institute of Standards and Technology (NIST)). The estimation condition for calculation was an evaporation temperature of 0° C., a condensation temperature of 40° C., a superheat degree for an evaporator of 5° C., a supercooling degree for a condenser of 5° C., and no loss. As a result, the vapor pressure at 25° C. of the former mixed refrigerant when a multi air conditioner for buildings is assumed was 1.46 MPa. Also, the vapor pressure at 25° C. of the latter mixed refrigerant when a refrigerator is assumed was 1.27 MPa.

Then, as indicated in Examples 1 to 20 and Comparative Examples 1 to 17 of Table 1, one of these mixed refrigerants and one of refrigerator oils A to C were combined, and the combination was evaluated for thermochemical stability. It is noted that to each of the refrigerator oils A to C used in Examples 1 to 20 and Comparative Examples 1 to 17, a stabilizer, acid scavenger, and extreme pressure agent were added as additives in amounts indicated in Table 1.

It is noted that designations such as “AA1”, “AG1”, and “EP1” in Additive of Table 1 represents the following components. In Added amount before testing of Additive in Table 1, a parenthesized value (for example, “(0.1)”) written along with a designation such as “AA1” indicates an added amount (unit: % by mass) of the written additive relative to a total mass of a refrigerator oil. That is, it indicates that the added amount before testing of the additive is 0.1% by mass relative to a total mass of a refrigerator oil. In Remaining amount after testing of Additive in Table 1, a parenthesized value (for example, “(65)”) written along with a designation such as “AA1” indicates a remaining amount (unit: %) of the additive relative to the added amount before testing. That is, it indicates that the remaining amount after testing of the additive is 65% relative to the added amount before testing. In Table 1, “-” in Added amount before testing indicates that an additive is not added, and “-” in Remaining amount after testing indicates that since an additive is not added, it is not contained.

### <Stabilizers AA1 and AA2>

AA1: 3,4-epoxycyclohexylmethyl-3,4-epoxycyclohexane carboxylate

AA2: d-limonene

### <Acid Scavengers AG1 and AG2>

AG1: alkyl (4 to 9 carbon atoms) glycidyl ester

AG2: 2-ethylhexyl glycidyl ether

### <Extreme Pressure Agents EP1 and EP2>

EP1: tricresyl phosphate

EP2: triphenyl phosphate

### <Refrigerator Oils A to C>

A: polyvinyl ether oil (PVE) having a kinematic viscosity at 40° C. of 67.8 mm²/s

B: polyvinyl ether oil (PVE) having a kinematic viscosity at 40° C. of 50.7 mm²/s

C: polyvinyl ether oil (PVE) having a kinematic viscosity at 40° C. of 31.8 mm²/s

### (Evaluation of Thermochemical Stability)

Into an enclosed electric compressor for refrigeration air-conditioning, a mixed refrigerant and a refrigerator oil are charged. The thermochemical stability between a mixed refrigerant and a refrigerator oil is one of important characteristics in terms of ensuring the long-term reliability of an apparatus. For evaluating thermochemical stability, a heating test was performed in the coexistence of a mixed refrigerant/a refrigerator oil using an autoclave. That is, “before testing” and “after testing” in Table 1 indicate before and after the heating test.

The heating test was performed as follows. It is noted that for performing the heating test, an antioxidant (DBPC (2,6-di-t-butyl-p-cresol), which does not affect the evaluation of thermochemical stability under a refrigerant environment, was added in an amount of 0.2% by mass to each of refrigerator oils. First, into a washed pressure container (pressure resistance: <20 MPa, inner capacity: 220 ml), a glass container was placed in such a manner as not to directly contact with container metal. Then, there were poured a refrigerator oil (50 g) which contains water adjusted to one of two levels of <100 ppm and 600 ppm (designated as “100 (ppm)” and “600 (ppm)” respectively in Water content in oil of Table 1) and a metal catalyst (Al, Cu, Fe: Φ2.0×300 mm) which was abraded with sandpaper, washed with acetone and ethanol, and shaped into a coil. Evacuation was performed such that the pressure of the system became 100 Pa or less. Then, the pressure container was connected to a refrigerant cylinder, introduced with 50 g of a mixed refrigerant, and thereafter heated in a constant-temperature bath at 175° C. for 504 hours.

After heating, the container was unsealed, and the total acid number of the refrigerator oil was measured in accordance with JIS K2501:2003 “Petroleum Products and Lubricants—Determination of Neutralization Number”. Also, the fluorine content in oil was measured by ion chromatography. Since trifluoroiodomethane is lower in thermochemical stability than HFC, heating it in the coexistence of low-compatible oil and water causes the generation of a fluorine compound as a reaction product between decomposition products of a mixed refrigerant and a refrigerator oil. Therefore, a higher fluorine content in oil indicates lower thermochemical stability with a mixed refrigerant. Using combustion-type ion chromatography, a test oil was burnt at 1000° C. so that a fluorine component was trapped by a hydrogen peroxide solution. Then, the fluorine component was poured into an ion chromatograph, and measured at an eluent (Na₂CO₃/NaHCO₃) flow rate of 1.5 ml/min using an electrical conductivity detector.

In this examination, it was judged acceptable indicating excellent thermochemical stability when the total acid number of a refrigerator oil was 0.30 mg KOH/g or less, and unacceptable indicating poor thermochemical stability when more than 0.30 mg KOH/g. Also, in this examination, it was judged acceptable indicating excellent thermochemical stability when the fluorine content in oil was 3000 ppm or less, and unacceptable indicating poor thermochemical stability when more than 3000 ppm. Also, the appearance of a metal catalyst after testing was observed. It was judged acceptable when the appearance of a metal catalyst was not discolored, and unacceptable when the appearance of the metal catalyst was somewhat discolored or discolored.

The remaining amounts of additives were quantified by gas chromatography. Measurement was performed using an FID (flame ionization detector) under a quantification condition by gas chromatography in which a test oil was diluted with acetone into 5%, and thereafter poured into a gas chromatograph. The evaluation result of thermochemical stability is indicated together with a component make-up of a mixed refrigerant and properties of a refrigerator oil in Table 1.

TABLE 1

| | | | | | | | Additive | | |
|---|---|---|---|---|---|---|---|---|---|
| | | Mixed refrigerant | | | | Water content | Added amount before testing (mass %) | | |
| | | (mass %) | | | Refrigeration | in oil | | Acid | Extreme |
| | | HFC32 | HFC125 | R13I1 | oil | (ppm) | Stabilizer | scavenger | pressure agent |
| Example | 1 | 50 | 10 | 40 | A | 100 | AA1(0.1) | AG1(0.5) | EP1(0.5) |
| | 2 | 50 | 10 | 40 | A | 100 | AA1(0.5) | AG1(0.5) | EP1(0.5) |
| | 3 | 50 | 10 | 40 | A | 600 | AA1(0.5) | AG1(0.5) | EP1(0.5) |
| | 4 | 50 | 10 | 40 | A | 100 | AA1(1.0) | AG1(0.5) | EP1(0.5) |
| | 5 | 50 | 10 | 40 | A | 100 | AA1(2.0) | AG1(0.5) | EP1(0.5) |
| | 6 | 50 | 10 | 40 | A | 100 | AA1(0.5) | AG1(0.1) | EP1(0.5) |
| | 7 | 50 | 10 | 40 | A | 100 | AA1(0.5) | AG1(2.0) | EP1(0.5) |
| | 8 | 50 | 10 | 40 | A | 100 | AA1(0.5) | AG1(0.5) | EP1(0.1) |
| | 9 | 50 | 10 | 40 | A | 100 | AA1(0.5) | AG1(0.5) | EP1(2.0) |
| | 10 | 50 | 10 | 40 | A | 100 | AA1(0.1) | AG1(0.1) | EP1(0.1) |
| | 11 | 50 | 10 | 40 | A | 100 | AA1(1.0) | AG1(1.0) | EP1(1.0) |
| | 12 | 50 | 10 | 40 | A | 100 | AA1(2.0) | AG1(2.0) | EP1(2.0) |
| | 13 | 50 | 10 | 40 | A | 100 | AA2(0.5) | AG1(0.5) | EP1(0.5) |
| | 14 | 50 | 10 | 40 | A | 100 | AA1(0.5) | AG2(0.5) | EP1(0.5) |
| | 15 | 50 | 10 | 40 | A | 100 | AA1(0.5) | AG1(0.5) | EP2(0.5) |
| | 16 | 50 | 10 | 40 | A | 100 | AA1(0.25) | AG1(0.5) | EP1(0.5) |
| | | | | | | | AA2(0.25) | | |
| | 17 | 50 | 10 | 40 | A | 100 | AA1(0.5) | AG1(0.25) | EP1(0.5) |
| | | | | | | | | AG2(0.25) | |
| | 18 | 50 | 10 | 40 | B | 100 | AA1(0.5) | AG1(0.5) | EP1(0.5) |
| | 19 | 50 | 10 | 40 | C | 100 | AA1(0.5) | AG1(0.5) | EP1(0.5) |
| | 20 | 28 | 17 | 55 | A | 100 | AA1(0.5) | AG1(0.5) | EP1(0.5) |
| Comparative | 1 | 50 | 10 | 40 | A | 100 | — | — | — |
| Example | 2 | 50 | 10 | 40 | A | 600 | — | — | — |
| | 3 | 50 | 10 | 40 | B | 100 | — | — | — |
| | 4 | 50 | 10 | 40 | C | 100 | — | — | — |
| | 5 | 28 | 17 | 55 | A | 100 | — | — | — |
| | 6 | 50 | 10 | 40 | A | 100 | — | — | EP1(0.5) |
| | 7 | 50 | 10 | 40 | A | 100 | — | — | EP2(0.5) |
| | 8 | 50 | 10 | 40 | A | 600 | — | — | EP1(0.5) |
| | 9 | 50 | 10 | 40 | B | 100 | — | — | EP1(0.5) |
| | 10 | 50 | 10 | 40 | C | 100 | — | — | EP1(0.5) |
| | 11 | 28 | 17 | 55 | A | 100 | — | — | EP1(0.5) |
| | 12 | 50 | 10 | 40 | A | 100 | AA1(0.5) | — | EP1(0.5) |
| | 13 | 50 | 10 | 40 | A | 100 | AA2(0.5) | — | EP1(0.5) |
| | 14 | 50 | 10 | 40 | A | 100 | — | AG1(0.5) | EP1(0.5) |
| | 15 | 50 | 10 | 40 | A | 100 | — | AG2(0.5) | EP1(0.5) |
| | 16 | 50 | 10 | 40 | A | 100 | AA1(0.05) | AG1(0.5) | EP1(0.5) |
| | 17 | 50 | 10 | 40 | A | 100 | AA1(3.0) | AG1(0.5) | EP1(0.5) |

| | | Additive | | | | Fluorine | |
|---|---|---|---|---|---|---|---|
| | | Remaining amount after testing (%) | | | Total acid | content in | |
| | | | Acid | Extreme | number | oil | Appearance of |
| | | Stabilizer | scavenger | pressure agent | (mg KOH/g) | (ppm) | metal catalyst |
| Example | 1 | AA1(65) | AG1(85) | EP1(90) | 0.12 | 1800 | Not discolored |
| | 2 | AA1(83) | AG1(83) | EP1(98) | 0.05 | 1200 | Not discolored |
| | 3 | AA1(72) | AG1(52) | EP1(78) | 0.06 | 1600 | Not discolored |
| | 4 | AA1(85) | AG1(89) | EP1(98) | 0.02 | 780 | Not discolored |
| | 5 | AA1(88) | AG1(93) | EP1(99) | 0.01 | 660 | Not discolored |
| | 6 | AA1(78) | AG1(67) | EP1(97) | 0.06 | 1300 | Not discolored |
| | 7 | AA1(83) | AG1(97) | EP1(96) | 0.02 | 1500 | Not discolored |
| | 8 | AA1(86) | AG1(79) | EP1(93) | 0.01 | 1600 | Not discolored |
| | 9 | AA1(72) | AG1(84) | EP1(97) | 0.11 | 1400 | Not discolored |
| | 10 | AA1(57) | AG1(74) | EP1(91) | 0.15 | 3000 | Not discolored |
| | 11 | AA1(89) | AG1(93) | EP1(96) | 0.08 | 480 | Not discolored |
| | 12 | AA1(91) | AG1(88) | EP1(95) | 0.06 | 370 | Not discolored |
| | 13 | AA1(75) | AG1(65) | EP1(88) | 0.09 | 1600 | Not discolored |
| | 14 | AA1(83) | AG2(63) | EP1(97) | 0.07 | 1300 | Not discolored |
| | 15 | AA1(80) | AG1(78) | EP1(95) | 0.06 | 1400 | Not discolored |
| | 16 | AA1(79) | AG1(75) | EP1(92) | 0.06 | 1400 | Not discolored |
| | | AA2(71) | | | | | |
| | 17 | AA1(75) | AG1(76) | EP1(84) | 0.07 | 1700 | Not discolored |
| | | | AG2(69) | | | | |
| | 18 | AA1(75) | AG1(71) | EP1(95) | 0.06 | 1300 | Not discolored |
| | 19 | AA1(68) | AG1(58) | EP1(92) | 0.06 | 1600 | Not discolored |
| | 20 | AA1(77) | AG1(59) | EP1(88) | 0.07 | 1700 | Not discolored |
| Comparative | 1 | — | — | — | 0.34 | 7200 | Somewhat discolored |
| Example | 2 | — | — | — | 0.55 | 10200 | Somewhat discolored |
| | 3 | — | — | — | 0.42 | 8100 | Somewhat discolored |
| | 4 | — | — | — | 0.45 | 8700 | Somewhat discolored |
| | 5 | — | — | — | 0.38 | 7700 | Somewhat discolored |
| | 6 | — | — | EP1(32) | 2.35 | 18600 | Discolored |
| | 7 | — | — | EP1(45) | 2.15 | 16700 | Discolored |
| | 8 | — | — | EP1(0) | 4.58 | 30600 | Discolored |
| | 9 | — | — | EP1(22) | 2.84 | 20300 | Discolored |
| | 10 | — | — | EP1(15) | 3.01 | 21900 | Discolored |
| | 11 | — | — | EP1(0) | 3.73 | 24700 | Discolored |
| | 12 | AA1(12) | — | EP1(84) | 0.52 | 3200 | Not discolored |
| | 13 | AA2(0) | — | EP1(69) | 0.89 | 4100 | Not discolored |
| | 14 | — | AG1(5) | EP1(0) | 1.97 | 6500 | Discolored |
| | 15 | — | AG2(0) | EP1(0) | 2.12 | 5800 | Discolored |
| | 16 | AA1(0) | AG1(20) | EP1(35) | 0.92 | 4200 | Discolored |
| | 17 | AA1(45) | AG1(96) | EP1(99) | 0.01 | 2100 | Not discolored |

Examples 1 to 20 were evaluated on whether thermochemical stability is improved by adding at least one of stabilizers AA1 and AA2 and at least one of acid scavengers AG1 and AG2 to one of refrigerator oils A, B, and C containing an indispensable extreme pressure agent EP1 or EP2.

As indicated in Table 1, Examples 1 to 20 satisfied aspects necessary for the present disclosure. Therefore, the increase of a total acid number (initial value: 0.01 mg KOH/g or less) was suppressed, the fluorine content in oil was suppressed, and furthermore, the appearance of a metal catalyst was not discolored. From these results, it was confirmed that Examples 1 to 20 are excellent in thermochemical stability.

On the other hand, since Comparative Examples 1 to 17 do not satisfy aspects necessary for the present disclosure, the increase of a total acid number (initial value: 0.01 mg KOH/g or less) was large, the fluorine content in oil was high, and a metal catalyst had been discolored. From these results, it was confirmed that Comparative Examples 1 to 17 were poor in thermochemical stability. Specific results of Comparative Examples 1 to 17 were as follows.

Comparative Examples 1 to 4 were evaluated for thermochemical stability between one of refrigerator oils A, B, and C and a trifluoroiodomethane-containing mixed refrigerant (HFC32/HFC125/R13I1 (trifluoroiodomethane)=50% by mass/10% by mass/40% by mass). In Comparative Examples 1 to 4, the increase of a total acid number (initial value: 0.01 mg KOH/g or less) was large, the fluorine content in oil was high, and a metal catalyst had been somewhat discolored, regardless of the kinematic viscosity of a refrigerator oil. It is noted that Comparative Example 2 was evaluated for thermochemical stability with a refrigerator oil having a high water content in oil. From the evaluation result of Comparative Example 2, it was understood that when aspects necessary for the present disclosure are not satisfied, an increased water content in the system causes the increases of both a total acid number and a fluorine content in oil to become large.

Comparative Example 5 was evaluated for thermochemical stability between a refrigerator oil A and a trifluoroiodomethane-containing mixed refrigerant (HFC32/HFC125/R13I1=28% by mass/17% by mass/55% by mass). The result of Comparative Example 5 was the same as that of Comparative Example 1, indicating poor thermochemical stability.

Also, Comparative Examples 6 to 10 were evaluated for thermochemical stability between one of refrigerator oils A, B, and C each added with 0.5% by mass of an extreme pressure agent EP1 or EP2 and a trifluoroiodomethane-containing mixed refrigerant (HFC32/HFC125/R13I1=50% by mass/10% by mass/40% by mass). It was understood that the total acid number and a fluorine content in oil of Comparative Examples 6 to 10 were significantly larger than Comparative Examples 1 to 5 in which an extreme pressure agent EP1 or EP2 was not added to a refrigerator oil. Also, the remaining amounts of the extreme pressure agents EP1 and EP2 after testing also had considerably decreased. Especially in Comparative Example 8 having a high water content in oil, the remaining amount of an extreme pressure agent was zero, indicating disappearance.

Comparative Example 11 was evaluated for thermochemical stability between a refrigerator oil A added with 0.5% by mass of an extreme pressure agent EP1 and a trifluoroiodomethane-containing mixed refrigerant (HFC32/HFC125/R13I1=28% by mass/17% by mass/55% by mass). Since Comparative Example 11 includes trifluoroiodomethane in a large amount, an extreme pressure agent disappeared, and both the total acid number and the fluorine content in oil increased, compared to Comparative Example 6.

Comparative Examples 12 to 15 were evaluated for thermochemical stability between a refrigerator oil A added with 0.5% by mass of an extreme pressure agent EP1 and 0.5% by mass of a stabilizer AA1 or AA2 or 0.5% by mass of an acid scavenger AG1 or AG2 and a trifluoroiodomethane-containing mixed refrigerant (HFC32/HFC125/R13I1=50% by mass/10% by mass/40% by mass). In Comparative Examples 12 to 15, the increase amount of a total acid number is somewhat lower than Comparative Example 6 in which a stabilizer and an acid scavenger are not added, but cannot be suppressed. Also, in Comparative Examples 12 to 15, an extreme pressure agent EP1, which is added for developing abrasion resistance of a refrigerator oil, drastically decreased, and stabilizers AA1 and AA2 as well as acid scavengers AG1 and AG2 were depleted. From the evaluation results of Comparative Examples 12 to 15, it was understood that in these embodiments, the refrigeration cycle apparatus is unlikely to achieve long-term reliability.

Here, when Examples 1 to 20 are examined again, Examples 1 to 20 include both a stabilizer AA1 or AA2 and an acid scavenger AG1 or AG2 added to a refrigerator oil A, B, or C containing an extreme pressure agent EP1 or EP2. Therefore, compared to Comparative Examples 6 to 11 which include neither a stabilizer nor an acid scavenger and Comparative Examples 12 to 15 which include only one of a stabilizer or an acid scavenger, it is understood that in Examples 1 to 20, the increase of a total acid number is significantly suppressed, and the fluorine content in oil also significantly decreases. In Examples 1 to 20, added additives remain in large amounts. This also demonstrates that thermochemical stability between a trifluoroiodomethane-containing mixed refrigerant and a refrigerator oil (polyvinyl ether oil) is considerably improved by a combination and types of added additives. It is also understood that when a plurality of stabilizers or a plurality of acid scavengers is added as indicated in Examples 16 and 17, excellent thermochemical stability can be obtained. In addition, it is understood that even when the water content in oil is as high as 600 ppm as indicated in Example 3, the depletion of additives somewhat increases, but both the total acid number and the fluorine content in oil are at a low level, demonstrating extraordinarily excellent thermochemical stability. Even in Example 20, which uses a mixed refrigerant containing a large amount of trifluoroiodomethane, the remaining amount of each additive is larger than Comparative Example 11, and the total acid number and the fluorine content in oil are smaller, demonstrating excellent thermochemical stability. That is, from the evaluation results of Examples 1 to 20, it was confirmed that even when a trifluoroiodomethane-containing mixed refrigerant is used, polyvinyl ether oil having poor thermochemical stability with a mixed refrigerant can be used as a refrigerator oil. It is noted that Examples 1 to 20, which use a mixed refrigerant based on three components of HFC32/HFC125/R13I1, are low in flammability, and have a GWP of 750 or less as described above.

Meanwhile, when a stabilizer AA1 and an acid scavenger AG1 were added, but the added amount of the stabilizer was less than 0.1% by mass like Comparative Example 16, it was confirmed that the increase of a total acid number was large, the fluorine content in oil increased, a metal catalyst was discolored, and all additives were depleted.

Also, when the added amount of a stabilizer AA1 was more than 2.0% by mass like Comparative Example 17, the increase of a total acid number was drastically suppressed, and the fluorine content in oil decreased, demonstrating excellent thermochemical stability, but a large amount of a deposit, which was considered a polymer of the additive itself, was observed in recovered oil. This raised the concern that when the content of a stabilizer added to a refrigerator oil is more than 2.0% by mass, the use of the refrigerator oil in a refrigeration cycle apparatus is impaired. This demonstrated that the added amount of the additive is desirably 2.0% by mass or less. Therefore, Comparative Example 17 was categorized as Comparative Example. In brief, Comparative Example 17 was categorized as Comparative Example, because although it was excellent in the results of a total acid number, a fluorine content in oil, and an appearance of a metal catalyst, and equivalent to Examples in terms of thermochemical stability, a large amount of a deposit considered a polymer of the additive itself was observed in recovered oil.

In consideration of the above-described result, the deterioration mechanism was further studied by identifying decomposition products of refrigerator oils used in the test through nuclear magnetic resonance and gas chromatography mass spectrometry. As a result, it was found that a stabilizer has the effect of trapping hydrofluoric acid and hydrogen iodide, and an acid scavenger has the function of reacting with water in an early stage to reduce a water content in oil. It was considered that this is because the addition of a combination of these additives to a refrigerator oil (polyvinyl ether oil) including an extreme pressure agent constituted by tertiary phosphate enables thermochemical stability with a trifluoroiodomethane-containing mixed refrigerant to become extraordinarily favorable.

### Example 21

With a 28 kW multi air conditioner for buildings which includes synthetic zeolite as a dryer in a refrigeration cycle apparatus including a scroll compressor as the above-described sealed electric compressor, a 3000-hour durability test under high speed, high load conditions was performed. The compressor was operated with a rotation speed of 6000 min⁻¹. A 250 μm heat resistant PET film (B type, 130° C.) was used for the insulation between an iron core and a coil of a motor, and a polyester imide-amide imide double coated copper wire was used for the main insulation of a coil.

A refrigeration cycle apparatus was charged with 8000 g of the trifluoroiodomethane-containing mixed refrigerant (HFC32/HFC125/R13I1=50% by mass/10% by mass/40% by mass) of Example 1 used as a refrigerant. A compressor was charged with 1500 ml of a combination of the refrigerator oil A of Example 2 as a refrigerator oil, and a stabilizer AA1 (0.5% by mass), an acid scavenger AG1 (0.5% by mass), and an extreme pressure agent EP1 (0.5% by mass) as additives.

This multi air conditioner for buildings was operated for 3000 hours, and thereafter the scroll compressor was disassembled to check the state of abrasion and the flaking occurrence state of a rolling bearing. The result of the durability test for Example 21 performed with this actual machine was as follows. It was found that the scroll compressor caused no flaking on rolling elements of a main bearing and a sub-bearing both constituted by a rolling bearing and on raceway surfaces of an inner ring and an outer ring, and that abrasion was rare in sliding portions such as wrap tips of a revolving scroll and a fixed scroll, and an Oldham ring. Also, the total acid number after testing of a refrigerator oil was as low as 0.03 mg KOH/g. Furthermore, the remaining amount was 70% for the added stabilizer AA1, 40% for the acid scavenger AG1, and 90% for the extreme pressure agent EP1, confirming that the additives remained in large amounts. This demonstrated that a refrigeration cycle apparatus that uses a combination of a stabilizer and an acid scavenger to polyvinyl ether oil containing an extreme pressure agent can achieve sufficient long-term reliability.

### Comparative Example 18

The same test as Example 21 was performed to Comparative Example 18 which uses, in the above-described Example 21, a combination of the refrigerator oil A of Comparative Example 12 as a refrigerator oil and a stabilizer AA1 (0.5% by mass) and an extreme pressure agent EP1 (0.5% by mass) as additives. As a result, flaking was observed on a main bearing constituted by a rolling bearing of the scroll compressor, and abrasion of sliding portions such as wrap tips of a revolving scroll and a fixed scroll, and an Oldham ring was observed more often than Example 21. The total acid number after testing of a refrigerator oil was as high as 0.35 mg KOH/g, and the remaining amount was 20% for the added stabilizer AA1, and 30% for the extreme pressure agent EP1, indicating considerable depletion. This demonstrated that a refrigeration cycle apparatus that does not use a combination of a stabilizer and an acid scavenger to polyvinyl ether oil containing an extreme pressure agent cannot achieve sufficient long-term reliability.

From the above-described results, it was found that the use of the refrigerant described in the present embodiment enables the achievement of an air-conditioner that is low in flammability and environmental load and is highly reliable even when a trifluoroiodomethane-containing mixed refrigerant is used. Also, it was found that the same effect can be obtained when a mixed refrigerant having the formulation of HFC32/HFC125/R13I1=28% by mass/17% by mass/55% by mass is used not only in the air-conditioner but also in the refrigerator indicated in FIG. 2.

According to the above-described embodiments and examples, there can be achieved a refrigeration cycle apparatus (an air-conditioner and a refrigerator) that is low in flammability, has a GWP of 750 or less, and can use, as a refrigerator oil, polyvinyl ether oil having poor thermochemical stability with a trifluoroiodomethane-containing mixed refrigerant, even when such a refrigerant is used.

Although the refrigeration cycle apparatus according to the present disclosure has been described in detail by embodiments and examples, the gist of the present disclosure is not limited to this description, and encompasses various variations. For example, the above-described embodiments have been described in detail to facilitate the understanding of the present disclosure, and the present disclosure is not necessarily limited to an embodiment including all of the above-described configuration. Also, the configuration of an embodiment can be partly replaced with the configuration of another embodiment, and the configuration of an embodiment can be added with the configuration of another embodiment. Also, the configuration of each embodiment can be partly subjected to addition, omission, and replacement of another configuration.

The refrigeration cycle apparatus according to the present disclosure is useful for an environmentally friendly air-conditioner or refrigerator.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A refrigeration cycle apparatus comprising:
a compressor that compresses a refrigerant;
a condenser that condenses the refrigerant compressed by the compressor;
a pressure reducer that reduces in pressure the refrigerant condensed by the condenser; and
an evaporator that evaporates the refrigerant reduced in pressure by the pressure reducer, wherein the refrigerant is a mixed refrigerant which contains refrigerant components of difluoromethane, pentafluoroethane and trifluoroiodomethane and which has a global warming potential of 750 or less and a vapor pressure at 25° C. of 1.1 MPa to 1.8 MPa,
the compressor is a sealed electric compressor which includes, in a sealed container, a compression mechanism and a motor to drive this compression mechanism, and which is charged with a refrigerator oil to lubricate a sliding portion, and
the refrigerator oil is polyvinyl ether oil, and contains 0.1% by mass to 2.0% by mass of a stabilizer constituted by at least one of an alicyclic epoxy compound and a monoterpene compound, 0.1% by mass to 2.0% by mass of an acid scavenger constituted by an aliphatic epoxy compound, and 0.1% by mass to 2.0% by mass of an extreme pressure agent constituted by tertiary phosphate.

2. The refrigeration cycle apparatus according to claim 1, wherein the mixed refrigerant has a refrigerant make-up in which with respect to a total mass of the mixed refrigerant, the difluoromethane is 30% by mass to 60% by mass, the pentafluoroethane is 5% by mass to 25% by mass, and the trifluoroiodomethane is 30% by mass to 60% by mass.

3. The refrigeration cycle apparatus according to claim 1, wherein the alicyclic epoxy compound is 3,4-epoxycyclohexylmethyl-3,4-epoxycyclohexane carboxylate.

4. The refrigeration cycle apparatus according to claim 1, wherein the monoterpene compound is monocyclic monoterpene.

5. The refrigeration cycle apparatus according to claim 1, wherein the aliphatic epoxy compound is at least one of alkyl glycidyl ester and alkyl glycidyl ether.

6. The refrigeration cycle apparatus according to claim 1, wherein the tertiary phosphate is tricresyl phosphate.
